(19) United States
(12) Patent Application Publication
(10) Pub. No.: US 2002/0174244 A1
(43) Pub. Date: Nov. 21, 2002

(54) System and method for coordinating, distributing and processing of data

(75) Inventors: Stephen Doyle Beckwith, Allentown, PA (US); Michele Zampetti Dale, Quakertown, PA (US); Ryan Scott Holmqvist, Basking Ridge, NJ (US); Farrukh Amjad Latif, Lansdale, PA (US)

Correspondence Address: Robert R. Axenfeld, Hitt Gaines & Boisbrun, P.C., Suite 225, 4647 Saucon Creek Rd., Center Valley, PA, 18034, US

(73) Assignee: TelGen Corporation, Lansing, MI

(21) Appl. No.: 09/861,429

(22) Filed: May 18, 2001

(51) Int. Cl. G06F 15/16

(52) U.S. Cl. 709/231; 709/100

(57) ABSTRACT

Dynamically distributing portions of process functionality among plural functional blocks. A plurality of service point functions are interspersed throughout each function block. Each service point function performs a portion of processing. A service point function may correspond to processing associated with a protocol layer. A service point function may be implemented in hardware, software or firmware with any of the multiple function blocks. After completion of each service point function, a sub-path is called to connect the completed service point function with a next service point function to be performed. The sub-path invokes a pointer which provides the next routine (e.g., the service point functionality) to be performed. If any one functional block is becoming overloaded, the system can simply change one sub-path, to route process functionality associated with a particular service point functionality to be performed in another functional block with the same capability programmed or hardwired therein. A collection of sub-paths form a logical processing path for the data. Accordingly, the present invention provides process functionality can be accomplished vertically be interspersing functional processing to any functional block be employing service points and sub-paths. Thus, it is possible to merge heterogeneous protocol translations and functionality (each at different protocol layers) with distributed processing involving multiple processing elements all on a single converged communications device.

### TECHNICAL FIELD OF THE INVENTION

The present invention is directed, in general, to data processing and, more specifically, to a system and method for coordinating processing of communications data between or among multiple functional blocks within a single platform servicing multiple heterogeneous multi-processing applications.

### BACKGROUND OF THE INVENTION

Conventional, multiprocessing systems, typically attempt to process data using a plurality of processing elements (also referred to as functional blocks) in a such a system. The well understood advantages of such systems, are that they combine processors to gain increased processor bandwidth. Most conventional multiprocessing systems borrow their architecture and processing techniques from processing of homogenous data. In such an environment, data load balancing is accomplished by spreading processing across the plurality of processing devices in such a device. So when one processing device is becoming overloaded with work, the multiprocessor system attempts to push-off data off that processor device to other processing devices for a more balanced processing approach. By distributing data across the multiple processors, the system is able to increase throughput and overall performance of the system. Such conventional multiprocessor systems are horizontal in nature. That is, they, work exceptionally well when processing homogenous data in a single protocol layer or single domain.

In a vertical environment, however, where there is heterogenous communications data composed of multiple and disparate protocols and protocol layers, it is very difficult to apply conventional data load balancing techniques, because each processor in such a system is typically dissimilar in nature and configured to perform very different processing techniques. Simple conventional pushing off of data to other devices to balance data processing loads in a heterogenous communication environment is very difficult and often not possible due to the dissimilar nature of the data and vertical layers associated with protocols. For instance, it isn't possible to mix a first layer protocol centric data with a device performing, for example a third layer protocol layer task.

A recurring problem with heterogenous communications data is the amount of resources needed to manage and track multiple data types and multiple protocol layers all converging into one processing platform. Another recurring problem in how to enable efficient use of all the system devices and enable them to operate synergistically with one another.

Typically, each functional processor, in a heterogeneous communications environment is designed to perform a fixed assigned task. Each functional block may be configured to operate hardwired in hardware, firmware, software or some combination thereof. If one or more functional blocks of a system are becoming overloaded with work, due to, for instance, too much incoming data, most try to redistribute the data loads. In order to redistribute data, it is often necessary to make changes to software coding or physical hardware designs to reallocate the data distribution, which can be time consuming, slow, expensive and complicated. Other systems rely on the central processor, or control processors, and/or operating systems to monitor and attempt to dynamically redistribute data loads, but as mentioned above, it is very difficult to distribute dissimilar data and mix protocol layers in a vertical heterogenous system.

There are many other problems associated with multiprocessor heterogenous comminations systems, that were not encountered with traditional homogeneous data multiprocessing systems. Such problems are probably too numerous and intricate to fully explain in this background section, nevertheless, a few more related problems may illustrate how difficult it is to solve processing, routing and data distribution in a heterogeneous multiple protocol communications environment.

Open Systems Interconnections (OSI) has made it possible for different systems made by different vendors to communicate by creating an open systems networking environment where any vendor's computer system, connected to any network, can freely share data with any other computer system on that network or a linked network. OSI created well-defined functional layers as a means to distribute processing across systems and networks. Such standardized functions allow different systems to communicate, where each layer in one system “talks” to its corresponding layer in another system; but only if they are using the same protocol.

Communication protocols provide the governing rules that define the way systems communicate and operate. To ensure that communication takes place, each system must understand the other's protocol. One issue facing many communication equipment manufactures is how to manage the diverseness of intercommunication data from divergent protocol environments converging into one processing platform supporting all these divergent protocol environments.

Network to network protocol communication is becoming relatively simple compared to gateway platforms that need to handle not only network-to-network protocol communication, but various other communication protocol paradigms. For example, interactive access devices, typically need to handle packet switched (route and control information is included as headers/trailers with data payload) and non packet switched data (route and control information is included as separate information before payload transfer). Packet type data generally refers to network communication, whereas non-packet switched data includes communications (such as voice and video) and Input/Output (I/O) (such as 1394, SCSI, and PCI). Packet type data protocols include Frame relay, TCP, ATM, whereas non-packet type data protocols include TDM and the aforementioned I/O connection-less oriented protocols.

So, the problem facing the industry is how to support all these divergent protocol environments converging into one platform or system, and if needed, (1) convert data traffic from one protocol paradigm (e.g., from packet-to-packet switched data, from ATM to ethernet, from voice TDM to ATM, etc.) in the same device, (2) maintain the characteristics of each protocol paradigm, and (3) provide expected quality of service for each protocol paradigm.

To better understand the complexity of the problem it should be useful to compare and contrast the various unrelated protocol and data characteristics converging on a single processing platform. This platform, maybe a convergence point between telephony, data, video and traditional, computer data in all formats, including packetized and non-packetized data. First, take for instance, peripheral devices, like printers as the first device supported by such a platform. Printers are supported by I/O non-packetized data. I/O data is error sensitive and requires guaranteed delivery, but is tolerant to latency (in other words real-time delivery is not critical).

In sharp contrast, non-packetized voice communication data is latency sensitive, but more error tolerant. So, a single platform has to deal not only with both these types of data and satisfy their needs. The single device may also be taxed with converting from one protocol paradigm to another with divergent requirements.

A single platform may also be likely tasked with processing and routing packet switched data and must also contend with varying levels of quality of service issues and format parameters necessary to meet each protocol supported by a platform. So besides converting from disparate protocol-to-protocol, data converging on a single platform must maintain quality of service standards and service formatting for each type of data in accordance with its protocol mediums.

With a device able to handle all these various protocol environments, the intra-working communications of the device/platform must afford it the ability to communicate and transfer data and maintain the quality of service characteristics described above. For example, how does the platform maintain communication with its central processor and I/O processors when converting from packet switched data to non-packet stitched data? How does a device, maintain protocol sensitive requirements (e.g., latencies or error tolerances) associated with each type of data and its associated protocol when communicating within its own domain to convert from one medium to another and then back again?

Tracking delivery of functional information through multiple protocol layers and across different protocol environments is extremely taxing on processing resources in communication devices. For instance, most integrated gateway systems, such as IADs, employ a host processor to control and allocate communication with other processes running on the same system. Often the host processor becomes over saturated with functional tasks associated with tracking and processing multiple protocol layers including real-time applications. As a result, the host processor is unable to provide quality of service in real-time, which severely damages the quality of interactive video and voice conversations. The system may start-to-back up and overwrite critical real-time data, while simultaneously starving out some non-real-time applications. Thus, if protocol information is not managed properly, overall system performance and quality of service suffers; especially the flow of time critical real-time data. Alternatively, such systems are limited by the number of real-time applications that they can support.

Devices that allow data traffic to enter and exit a between incompatible and/or compatible communication protocol paradigms need to be able convert data codes and transmission protocols to enable interoperability. Accordingly, what is needed in the art is a single communications platform, able to convert various converging data traffic from one protocol suite to another, while maintaining the characteristics of each and providing expected quality of service. Also, what is needed is a system and method for coordinating processing of data (including the ability to handle real-time data such as voice and video) in such a system such that processing is handled robustly and seamlessly. Also what is needed is a multiprocessing communications platform, able to dynamically distribute and adjust routing of data, to ensure maximum efficiency.

### SUMMARY OF THE INVENTION

To address the above-discussed deficiencies of the prior art, the present invention provides a communications device and a method of processing, distributing and routing communications data. In one embodiment of the present invention a processing platform includes a plurality of processing elements, configured to process and route data. A plurality of service points are located within the plurality of processing elements so that at least one of the plurality of service points is located within each of the plurality of processing elements. Each of the service points are configured to perform a portion of processing of the data. A plurality of sub-paths, are programmably configured to link a completion of processing of one of the service points to a start of processing of another of the service points, such that each portion of processing of the data can be performed in a specific order and at any location within the plurality of processing elements specified by the sub-paths.

Any of the sub-paths may be modified on the fly to redistribute process function off one processing element to another, without the need re-code or re-tool and of the processing elements. For example, if one processing device servicing a physical wire interface is becoming overloaded with a processing load, portions of that load may be moved off that functional element and performed else where, simple be modifying one or more sub-paths.

Another key feature of the present invention, is the ability to distribute service points across various functional modules. This provides the ability to balance or time the system;—a feature very effective and useful to balance real-time processing needs of audio and video (real-time) type data.

The present invention therefore introduces the broad concept of dynamically distributing portions of process functionality among plural functional blocks. A plurality of service point functions are interspersed throughout each functional block. Each service point function performs a portion of processing. A service point function may be implemented in hardware, software or firmware within any of the multiple function blocks. After completion of each service point function, a sub-path is called to connect the completed service point function with a next service point function to be performed. The sub-path invokes a pointer which provides the next routine (e.g., the service point functionality) to be performed. If any one functional block is becoming overloaded, the system can simply change one sub-path, to route process functionality associated with a particular service point functionality to be performed to another functional block with the same capability programmed or hardwired therein. A collection of sub-paths from ingress to egress of data from the communications platform form a logical processing path for the data.

Accordingly, the present invention provides process functionality that can be accomplished vertically be interspersing functional processing to any functional block by employing service points and sub-paths. Thus, it is possible to merge heterogeneous protocol translations and functionality (each at different protocol layers) with distributed processing involving multiple processing elements.

Another advantage of the present invention, is the ability to track data processing from service point-to-service point through the use of sub-paths and logical paths. Programming of sub-paths can take place on the fly, since they are stored in memory or are cached for quick access. Thus, the present invention allows dynamic modification of the functionality performed by the various multiple functional devices. There is no requirement to modify hardware, software or firmware code to reconfigure a logical path of where to perform functionality.

The present invention also provides a means to manage processing load balance by dynamically moving process functionality, from one processing element to another, if such processing element is becoming overwhelmed with processing tasks. The present invention therefore introduces the broad concept of coordinating processing among plural functional blocks by defining service points in portions of the processing and employing those service points as for generation of coordinating messages. In this manner, prior art polling and interrupts, and their associated inefficiencies can be avoided.

In one embodiment of the present invention, the plurality of functional blocks comprise a microprocessor. In a related embodiment, the plurality of functional blocks comprise a digital signal processor. Those having skill in the pertinent art will understand, however, that the present invention is not limited to a particular type or number of functional block.

In one embodiment of the present invention, the service point exists on a separate protocol layer of the device. In an embodiment to be illustrated and described, the device is architected with a separate service point layer in which communication of messages responsive to service points occurs. Of course, service points can be integrated into other architectural layers.

In one embodiment of the present invention, the service point occurs at a termination of the each of the portions. Alternatively, the service point can occur at an intermediate point in the portion to allow processing to be handed off temporarily to another functional block and thereafter returned.

In one embodiment of the present invention, the logical path is based on a protocol environment surrounding the device. A device's “protocol environment” includes the various protocols and communication speeds with which the device must deal. In an embodiment to be illustrated and described, the device is architected with a separate service point layer in which communication of messages responsive to service points occurs. Of course, service points can be integrated into other architectural layers.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The present invention will be described with reference to the accompanying drawings, wherein:

FIG. 1 shows a multi-protocol environment that a communication device maybe employed, in accordance with one embodiment of the present invention.

FIG. 2 is a block diagram of a communication device according to a an illustrative embodiment of the present invention.

FIG. 3 is a block diagram of sample hardware used in an Intelligent Protocol Engine in accordance with an illustrative embodiment of the present invention.

FIG. 4 shows a lower-level block diagram of an Intelligent Protocol Engine, according to an illustrative embodiment of the present invention.

FIG. 5 is a functional architecture block diagram illustrating how primary functional attributes are partitioned in a communication device according to an illustrative embodiment of the present invention.

FIG. 6 is a high-level block diagram of select processing elements in a communications device and various protocol layers supported by such elements according one illustrative embodiment of the present invention.

FIG. 7 is a block diagram showing a configuration hierarchy of functional processing in two representative functional blocks, according to one implementation of the present invention.

FIG. 8 is a block diagram of a communication device showing an expanded conceptual view of service point layers and service points, according to one implementation of the present invention.

FIG. 9 is a high-level block diagram of a global queue generally located in a messaging subsystem, according one example implementation of the present invention.

FIG. 10A shows a conceptual view of a logical data path traversing a generic multiple processor element system 1000 according to one embodiment of the present invention.

FIG. 10B is ablock diagram where an representation is made to show how identical service point functionality SP3 can be moved from one processing element to another in system 1000, according to one embodiment of the present invention.

FIG. 10C is a block diagram showing data ingress and egress paths from ATM to Ethernet functional blocks employing configuration tables according to one embodiment of the present invention.

FIG. 10D shows that sub-path pointers may be implemented in a queue structure, according to one embodiment of the present invention.

FIG. 11 is a block diagram illustrating transfer of data from Ethernet to an ATM protocol environment in a communication device, according one illustrative embodiment of the present invention.

FIG. 12 is a block diagram showing example Buffer State Entries and Transaction State Entries, according to an illustrative embodiment of the present invention.

FIG. 13 is another conceptual view of a logical path and sub-paths according an illustrative embodiment of the present invention.

### DETAILED DESCRIPTION

The following description is presented to enable a person skilled in the art to make and use the invention and is provided in the context of a particular application and its requirements. Various modifications to the preferred embodiment will be readily apparent to those skilled in the art and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein. The preferred embodiments of the invention are now described with reference to the figures where like reference numbers indicate identical or functionally similar elements. Also in the figures, the left most digit of each reference number corresponds to the figure in which the reference number is first used.

It is envisioned that the present invention may be adopted for various roles, such as routers, gateways and computers, to effectively transmit and process data; especially streaming media. One feature of the present invention is its ability to effectively decrease computations associated with processing protocol layers, decreasing latency times, and increasing throughput of communication systems by effectively managing distribution of data in the system. A key feature of the present invention, is the ability to distribute service points across various functional modules. This provides the ability to balance or time the system—a feature very effective and useful to balance real-time processing needs of audio and video (real-time) type data.

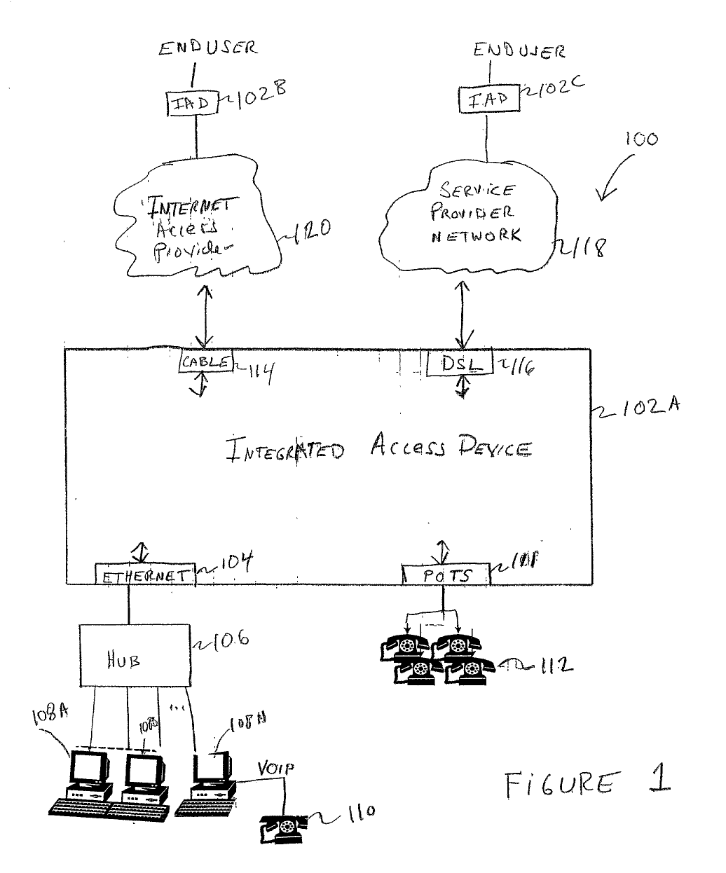

FIG. 1 shows a multi-protocol environment 100 where a communication device 102 may be employed, in accordance with one embodiment of the present invention. In this example, communication device 102 is an integrated access device (IAD) that bridges two networks. That is, IAD 102 concurrently supports voice, video and data and provides a gateway between other communication devices, such as individual computers 108, computer networks (in this example in the form of a hub 106) and/or telephones 112 and networks 118, 120. In this example, IAD 102A supports data transfer between an end user customer's site (e.g., hub 106 and telephony 112) and internet access providers 120 or service providers' networks 118 (such as Sprint Corp., AT&T and other service providers). More specifically, IAD 102 is a customer premise equipment device supporting access to a network service provider.

Nevertheless, it is envisioned that IAD 102 may be used and reused in many different types of protocol gateway devices, because of its adaptability, programmability and efficiency in processing real-time data as well as non-real-time data. As shall become appreciated to one skilled in the art, the architecture layout of device 102 (to be described in more detail below) may very well serve as a footprint for a vast variety of communication devices including computers.

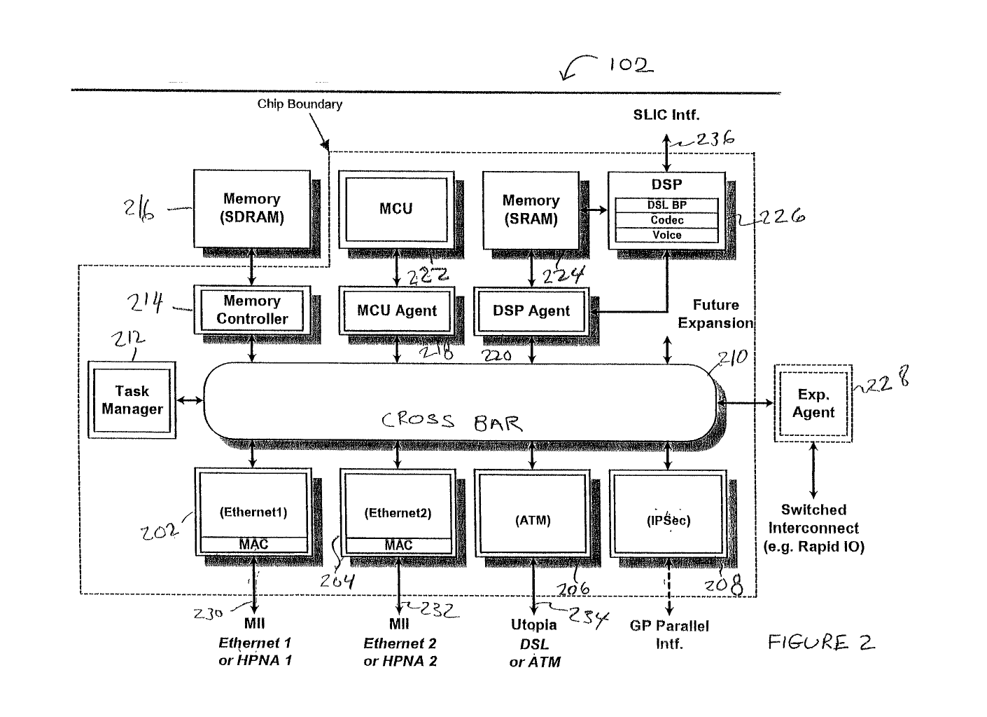

FIG. 2 is a block diagram of device 102 according to an illustrative embodiment of the present invention. Device 102 is preferably implemented on a single integrated chip to reduce cost, power and improve reliability. Device 102 includes intelligent protocol engines (IPEs) 202-208, a cross bar 210, a function allocator (also referred to as a task manager module (TMM)) 212, a memory controller 214, a Micro Control Unit (MCU) agent 218, a digital signal processor agent 220, a MCU 222, memory 224 and a DSP 226.

External memory 216 is connected to device 102. External memory 216 is in the form of synchronized dynamic random access memory (SDRAM), but may employ any memory technology capable of use with real-time applications. Whereas, internal memory 224 is preferably in the form of static random access memory, but again any memory with fast access time may be employed. Generally, external memory 216 is unified (i.e., MCU code resides in memory 216 that is also used for data transfer) for cost sensitive applications, but local memory may be distributed throughout device 102 for performance sensitive applications such as internal memory 224. Local memory may also be provided inside functional blocks 202-208, which shall be described in more detail below.

Also shown in FIG. 2, is an expansion port agent 228 to connect multiple devices 102 in parallel to support larger hubs. For example, in a preferred embodiment, device 102 supports 4 POTS, but can easily be expanded to handle any number of POTS such as a hub. Intelligent protocol engines 202-208, task manager 212 and other real-time communication elements such as DSP 226 may also be interchangeably referred to throughout this description as “functional blocks.”

Data enters and exits device 102 via lines 230-236 to ingress/egress ports in the form of IPEs 202-206 and DSP 226. For example voice data is transmitted via a subscriber line interface circuit (SLIC) line 236, most likely located at or near a customer premise site. Ethernet type data, such as video, non-real-time computer data, and voice over IP, are transmitted from data devices (shown in FIG. 1 as computers 108) via lines 230 and 232. Data sent according to asynchronous transfer mode (ATM), over a digital subscriber line (DSL), flow to and from service provider's networks or the internet via port 234 to device 102. Although not shown, device 102 could also support ingress/egress to a cable line (not shown) or any other interface.

The general operation of device 102 will be briefly described. Referring to FIG. 2, device 102 provides end-protocol gateway services by performing initial and final protocol conversion to and from end-user customers. Device 102 also routes data traffic between an internet access/service provider network 118, 120, shown in FIG. 1. Referring back to FIG. 2, MCU 222 handles most call and configuration management and network administration aspects of device 102. MCU 222 also may perform very low priority and non-real-time data transfer for device 102, which shall be described in more detail below. DSP 226 performs voice processing algorithms and interfaces to external voice interface devices (not shown). IPEs 202-208 perform tasks associated with specific protocol environments appurtenant to the type of data supported by device 102 as well as upper level functions associated with such environments. TMM 212 manages flow of control information by enforcing ownership rules between various functionalities performed by IPEs 202-208, MCU 222 or DSP 226.

Most data payloads are placed in memory 216 until IPE's complete their assigned tasks associated with such data payload and the payload is ready to exit the device via lines 230-236. The data payload need only be stored once from the time it is received until its destination is determined. Likewise time critical real-time data payloads can be placed in local memory or buffer (not shown in FIG. 2) within a particular IPE for immediate egress/ingress to a destination or in memory 224 of the DSP 226, bypassing external memory 216. Most voice payloads are stored in internal memory 224 until IPEs 202-208 or DSP 226 process control overhead associated with protocol and voice processing respectively.

A cross bar 210 permits all elements to transfer data at the rate of one data circuit per clock cycle without bus arbitration further increasing the speed of device 102. Cross bar 210 is a switching fabric allowing point-to-point connection of all devices connected to it. Cross bar 210 also provides concurrent data transfer between pairs of devices. In a preferred embodiment, the switch fabric is a single stage (stand-alone) switch system, however, a multi-stage switch system could also be employed as a network of interconnected single-stage switch blocks. A bus structure or multiple bus structures (not shown) could also be substituted for cross bar 210, but for most real-time applications a crossbar is preferred for its speed in forwarding traffic between ingress and egress ports (e.g., 202-208, 236) of device 102. Device 102 will now be described in more detail.

IPEs 202-208 primarily handle specific real-time control functions associated with multiple protocol environments. This relieves MCU 222 of the burden of processing and tracking massive amounts of overhead and control information, such as initialization call set-up/tear-down. Off-the-shelf communication processors from readily available commercial sources can be employed as MCU 222. MCU 222 is also used to reassign tasks to IPEs 202-208 (via sub-paths or a logical path to be described), in the event task manager 212 notifies MCU 222 that any one of the IPEs 202-208 are over or under utilized.

MCU 222 is connected to an MCU agent 218 that serves as an adapter for coupling MCU 222 to cross bar 210. Agent 218 makes the cross bar 210 transparent to MCU 222 so it appears to MCU 222 that it is communicating directly with other elements in device 102. As appreciated by those skilled in the art, agent 218 may be implemented with simple logic and firmware tailored to the particular commercial off-the-shelf processor selected for MCU 222.

DSP 226 may be selected from any of the off-shelf manufactures of DSPs or be custom designed. DSP 226 is designed to perform processing of voice and/or video. In the embodiment shown in FIG. 2, DSP 226 is used for voice operations. DSP agent 220 permits access to and from DSP 226 from the other elements of device 102. Like MCU agent 218, DSP agent 220 is configured to interface with the specific commercial DSP 226 selected. Those skilled in the art appreciate that agent 220 is easily designed and requires minimal switching logic to enable an interface with cross bar 210.

TMM 212 acts as a function coordinator and allocator for device 102. That is, TMM 212 tracks flow of control in device 102 and associated ownership to tasks assigned to portions of data as data progresses from one device (e.g., 202) to another device (e.g., 226).

Additionally, TMM 212 is responsible for tracking functions to be performed by devices connected to cross bar 210. TMM 212 employs queues to ensure that functionality is assigned to functional blocks based on the protocol environment data received by device 102. TMM 212 notifies each functional block, e.g., IPE 202 that a task is ready to be transferred for IPE 202 to perform. When IPE 202 receives a notification, it downloads information associated with such tasks for processing and TMM 212 queues more information for IPE 202. As mentioned above, TMM 212 also controls the logical ownership of protocol specific information associated with data payloads, since device 102 uses shared memory. The functionality and information about a destination (as a result of processing a portion of a protocol corresponding to protocol layer) is configured into functional blocks 202-208. This information is configured/established at initialization time. When a functional module needs to send information to destination outside of it, (a different functional module) it requests coordination of that information through TMM 212. In essence this control enables TMM 212 to perform a semaphore function.

It is envisioned that more than one TMM 212 can be employed in a hub consisting of several devices 102 depending on the communication processing demand of the application. In another embodiment, as mentioned above, a high and low water mark in TMM 212 can be used to ascertain whether any one functional block is over or under-utilized. In the event either situation occurs, TMM 212 may notify MCU 222 to reconfigure IPEs 202-208 (via sub-paths to be described) to redistribute the functional workload in more balanced fashion. In a preferred embodiment, the core hardware structure of a TMM 212 is the same as IPEs 202-208, described in more detail as follows.

IPEs 202-208 are essentially scaled-down area-efficient micro-controllers specifically designed for protocol handling and real-time data transfer speed. IPEs 202 and 204 are assigned to provide ingress/egress ports for data associated with an Ethernet protocol environment. IPE 206 serves as an ingress/egress port for data associated with an ATM protocol environment. IPE 208 performs a collection of IP security measures such as authentication of headers used to verify the validity of originating addresses in headers of every packet of a packet stream. Additional, IPEs may be added to device 102 for added robustness or additional protocol environments, such as cable. The advantage of IPEs 202-208 is that they are inexpensive and use programmable state machines, which can be reconfigured for certain applications.

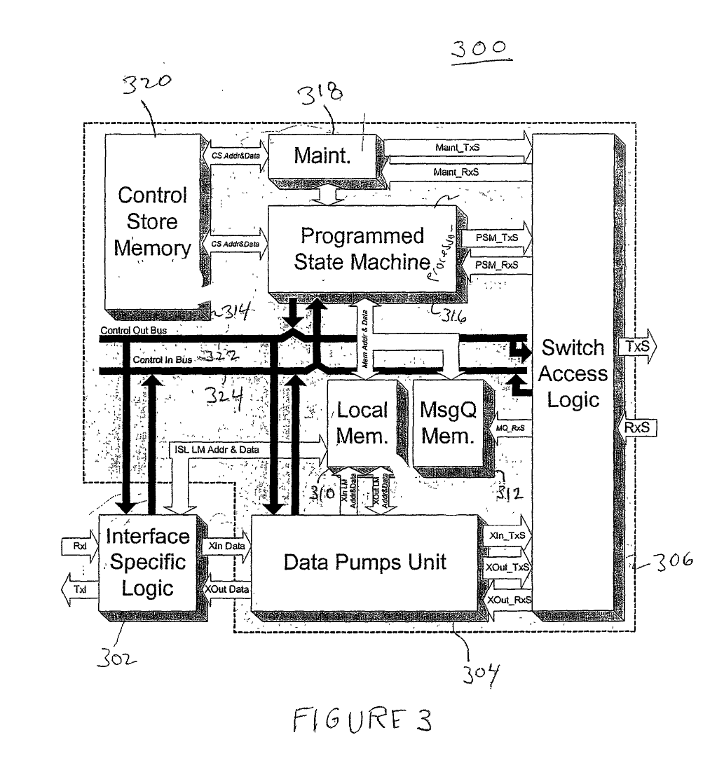

FIG. 3 is a block diagram of sample hardware used in an IPE 300 in accordance with a preferred embodiment of the present invention. Other than interface specific hardware, it is generally preferred that the hardware of IPEs remain uniform. IPE 300 includes: an interface specific logic 302, a data pump unit 304, switch access logic 306, local memory 310, a message queue memory 312, a programmed state machine 316, a maintenance block 320, and control in and out busses 322, 324. Each element of IPE 300 will be described in more detail with reference to FIG. 3. Programmed state machine 316 is essentially the brain of an IPE. It is a micro-programmed processor. IPE 300 may be configured with instruction words that employ separate fields to enable multiple operations to occur in parallel. As a result, programmed state machine 316 is able to perform more operations than traditional assembly level machines that perform only one operation at a time. Instructions are stored in control store memory 320. Programmed state machine 316 includes an arithmetic logic unit (not shown, but well known to those skilled in the art) capable of shifting and bit manipulation in addition to arithmetic operations. Programmed state machine 316 controls most of the operations throughout IPE 300 through register and flip-flop states (not shown) in IPE via Control In and Out Busses 322, 324. Busses 322, 324 in a preferred embodiment are 32 bits wide and can be utilized concurrently. It is envisioned that busses 322, 324, be any bit size necessary to accommodate the protocol environment or function to be performed in device 102. It is envisioned, however, that any specific control or bus size implementation could be different and should not be limited to the aforementioned example.

Switch access logic 306 contains state machines necessary for performing simultaneous transmit and receive operations to other elements in device 102. Switch access logic 306 also contains arbitration logic that determines which requester within IPE 300 (such as programmed state machine 316 or data pump unit 304) obtains a next transmit access to cross bar 210 as well as routing required information received from cross bar 210 to appropriate elements in IPE 300.

Maintenance block 318 is used to download firmware code that is downloaded during initialization or re-configuration of IPE 300. Such firmware code is used to program the programmed state machine 316 or debug a problem in IPE 300. Maintenance block 318 should preferably contain a command queue (not shown) and decoding logic (not shown) that allow it to perform low level maintenance operation to IPE 300. In one implementation, maintenance block 318 should also be able to function without firmware because its primary responsibility is to perform firmware download operations to control store memory 320.

In terms of memory, control store memory is primarily used to supply programmed state machine 316 with instructions. Message queue memory 312 receives asynchronous messages sent by other elements for consumption by programmed state machine 316. Local memory 310 contains parameters and temporary storage used by programmed state machine 316. Local memory 310 also provides storage for certain information (such as headers, local data and pointers to memory) for transmission by data pump unit 304.

Data pump unit 304 contains a hardware path for all data transferred to and from external interfaces. Data pump unit 304 contains separate ‘transfer out’ (Xout) and ‘transfer in’ (Xin) data pumps that operate independently from each other as a full duplex. Data pump unit 304 also contains control logic for moving data. Such control is programmed into data pump unit 304 by programmed state machine 316 so that data pump unit 304 can operate autonomously so long as programmed state machine 316 supplies data pump unit 304 with appropriate information, such as memory addresses.

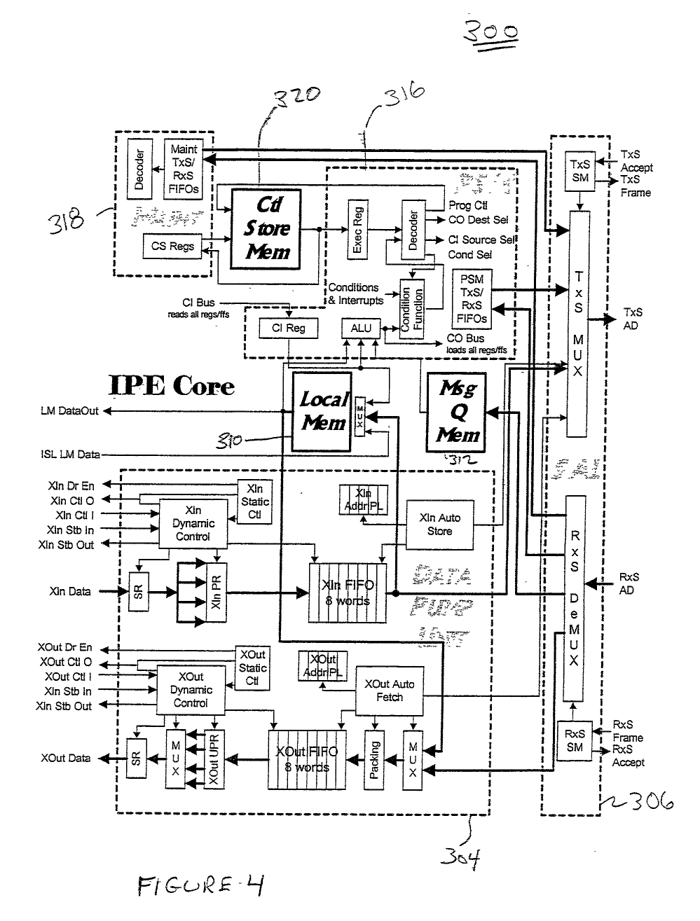

FIG. 4 shows a lower-level block diagram of an IPE 400, according to an illustrative embodiment of the present invention. IPE 400 is identical to IPE 300 except it shows more internal connections to enable one skilled in the art to easily design and implement an IPE. It should be noted that in the preferred embodiment, IPE 400 is substantially a synchronous device operating with a positive-edge system clock, although other clocking systems may easily be substituted. One advantage of IPE 400 is that its hardware core can easily be replicated to serve as a common hardware for all IPEs, and functionality of IPE 400 is configurable via their programmable state machine 316. Accordingly, by employing programmable state machines as the core of an IPE, manufactures of communication devices are able to reduce time-to-market focusing on core functionality in firmware, rather than a time consuming and tedious process of developing Application Specific Integrated Circuits (ASIC).

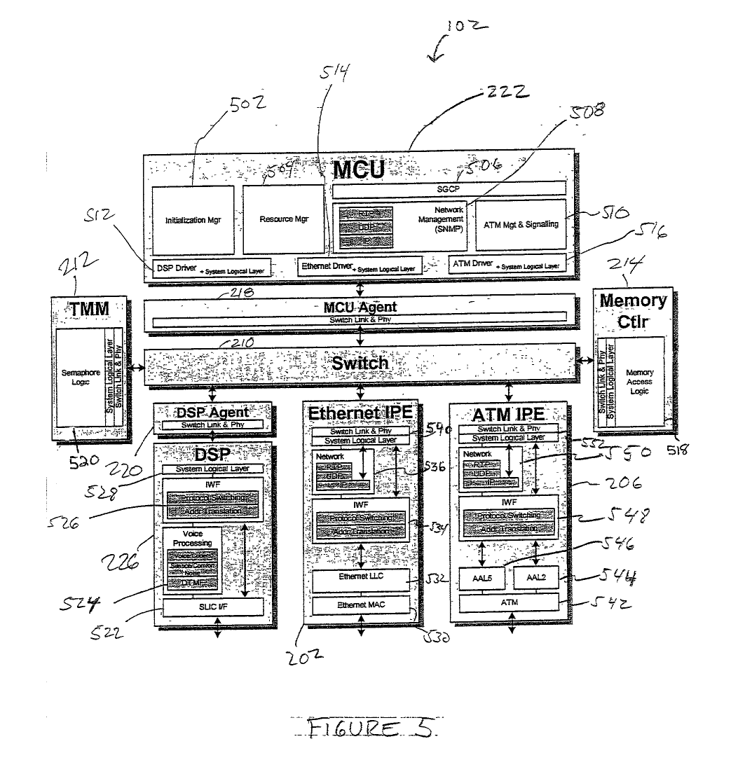

FIG. 5 is a functional architecture block diagram illustrating how primary functional attributes are partitioned in device 102. According to this example of the present invention, MCU 222 supports: call management initialization 502, resource management 504 of device 102, Simple Gate Control Protocols (SGCP) 506 or other protocols (e.g., MGCP, M.323, SIP, etc.), network management (e.g., SNMP) 508, ATM management and signaling 510, a DSP driver 512, and driver functions (an Ethernet driver 514, and an ATM driver 516). TMM 212 contains semaphore logic that performs function coordination or shared resource allocation between devices connected to switch 210. DSP 220 contains all attributes associated with voice processing which is readily appreciated by those skilled in the art.

IPE 202 performs Ethernet protocol functions necessary to either send Ethernet data over DSL, or through the DSP to convert to voice. IPE 202 also performs Ethernet protocol functions to data received from other protocol mediums and encapsulates the data with control so that communication of the data is transferable to devices in an Ethernet protocol domain. In this embodiment, IPE 202 supports Ethernet I functionality including: Ethernet MAC 530 for LAN connections, Ethernet Logical Link Control (LLC) 532, Inter Working Function (IWF) 534, network layer, function for Internet Protocol 536, and system logical layer/switch link function 540.

IPE 206, performs ATM protocol functions necessary to either send data to the DSP to convert to audio or to IPE 202 for conversion to Ethernet. IPE also performs ATM protocol functions to data received from other protocol mediums and encapsulates the data in the form of cells so that communication of the data is transferable to devices in an ATM protocol domain. In this embodiment, IPE 206 performs and prioritizes functionality at International Telecommunication Union (ITU) standard levels AAL5 and AAL2. Of course, other ITU and OSI functionality could be supported in other IPEs depending on the application for which device 102 is implemented. Those skilled in the art will readily appreciate the level of functionality supported by device 102 based on a review of FIG. 5. Those skilled in the art will also readily appreciate that protocol level functionality may be allocated in many other combinations including distribution to more IPEs. Additionally, various levels of functionality supported in a protocol can be increased or diminished depending on the application of device 102.

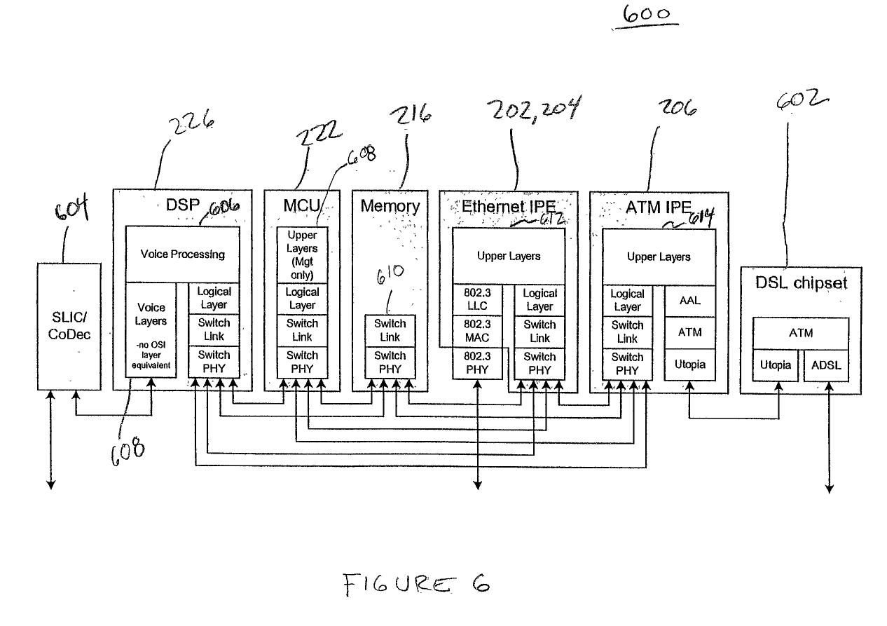

FIG. 6 is a high-level block diagram of select processing elements 600 in device 102 and various protocol layers supported by such elements 600 according one illustrative embodiment of the present invention. What is significant from the diagram of FIG. 6, is the nature of heterogeneous protocol environments device 102 must operate and the multiple/hetergenous protocol layers data must transverse as data flows in/out of device 102. The present invention efficiently manages and processes communications data and reduces memory read/writes and interrupts of MCU 222. As such, the present invention is able to provide real-time communication with quality of service and reduce latency delays associated with processing of data in a heterogeneous protocol environment.

Before describing a detailed illustrative embodiment of data flow management, it is helpful to understand the various protocol layers supported by device 102 and to view the different paths data may need to take as it traverses device 102. Starting from left to right in FIG. 6, subscriber line interface circuit (SLIC)/coder/decoder (CoDec) 604, is connected to DSP 226. As explained above, telephony services can be connected to SLIC/CoDec 604, which are processed through DSP 226. As shown in block 606, DSP 226 supports voice layers, voice processing (ingress/egress pinnacle). MCU 222 handles high-level management shown in block 608, including: upper management, logical switch link (which is similar in functionality to OSI logical layer, but is defined by a specific intra-working functionality of a system) and switch physical (PHY) layers. Memory 216 stores portions of data associated with switch link and PHY layers as shown in block 610. Referring to blocks 612 of Ethernet IPEs 202, 204 support IEEE 802.3 logical link control (LLC), Media Access Control (MAC) and PHY, as well as Logical, switch link and switch PHY. ATM IPE 206, as shown in block 614, supports: logical, switch link, switch PHY, ATM adaptation layer (AAL), ATM and Utopia layers. Finally, a DSL chipset 602, supporting Utopia, is connected to device 102. Other protocol layers could be supported by device 102, by programming IPEs 202-208.

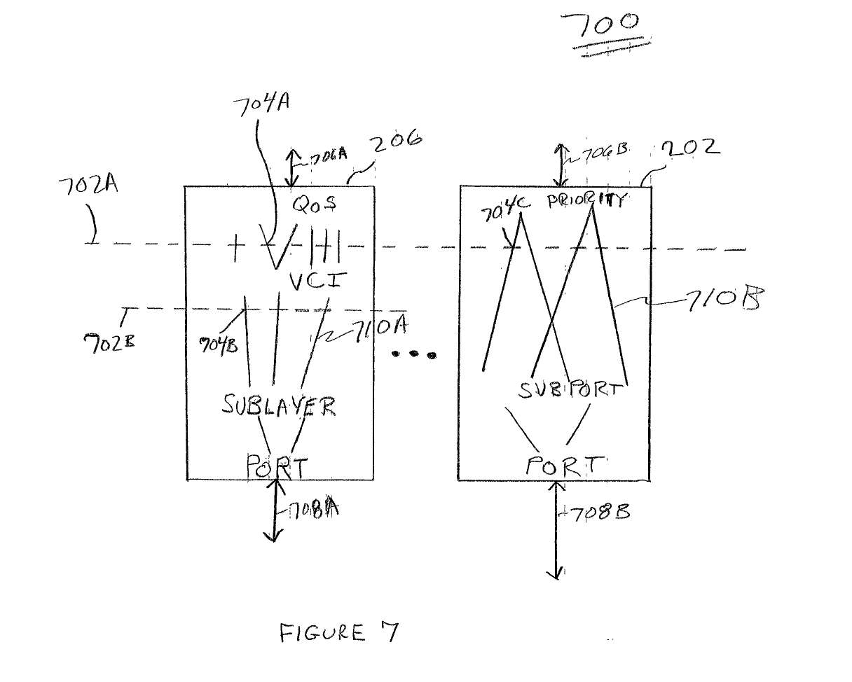

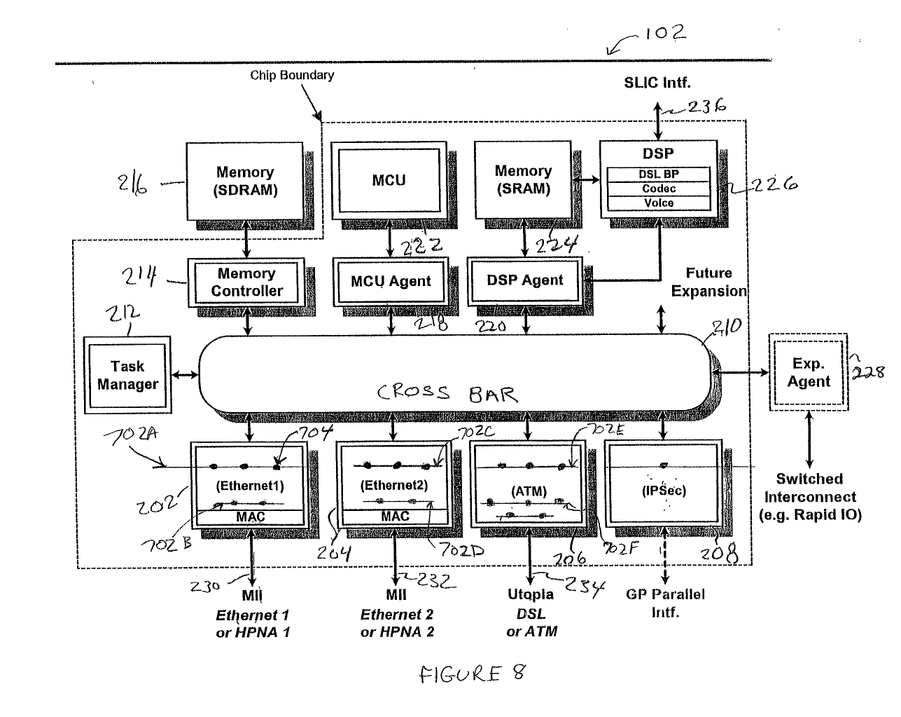

FIG. 7 is a block diagram showing a configuration hierarchy 700 of functional processing in two representative functional blocks 202, 206, according to an illustrative embodiment. In hierarchy 700, there are service point planes 702 in each IPE 202, 206. The planes represent different levels of protocol layer functional processing that are configured into an IPE 202, 206. Each service point 704 is a particular function performed on portions of data as it flows in either direction (ingress/egress) in IPEs 202,206. A collection of service points 704, from ingress to egress of communication data, forms a logical path 710. As data flows through the IPEs 202, 206, it intercepts a service point 704 on each plane 702 that causes generation of a function to be performed and the data portion is sent to a next service point 704 (which may reside on another device) forming a logical data path 710. FIG. 8 is a block diagram of device 102 showing an expanded conceptual view of service point layers 702 and service points 704, according to one implementation of the present invention.

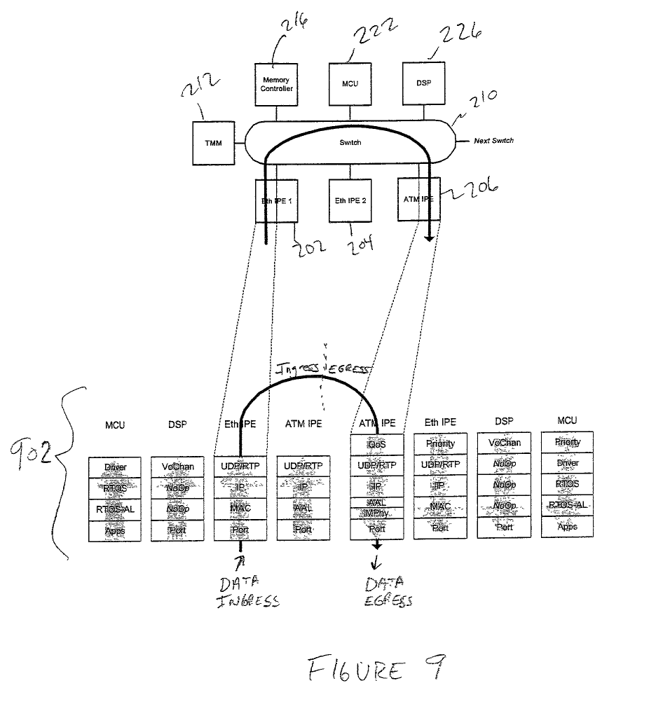

FIG. 9 is a high-level block diagram showing an Ethernet IPE 202 sending communications data to an ATM IPE 206. Located within each block as will be described are service points which are chunks of processing functionality configured to process the data as it traverses IWF layers needed to support protocol conversation from one protocol environment to another. A sample representation of these layers are shown generally as 902. Depending on the IWF, quality of service and specific requirements of a system, additional layers maybe added or skipped as data moves from layer-to-layer and IPE 202 to IPE 206.

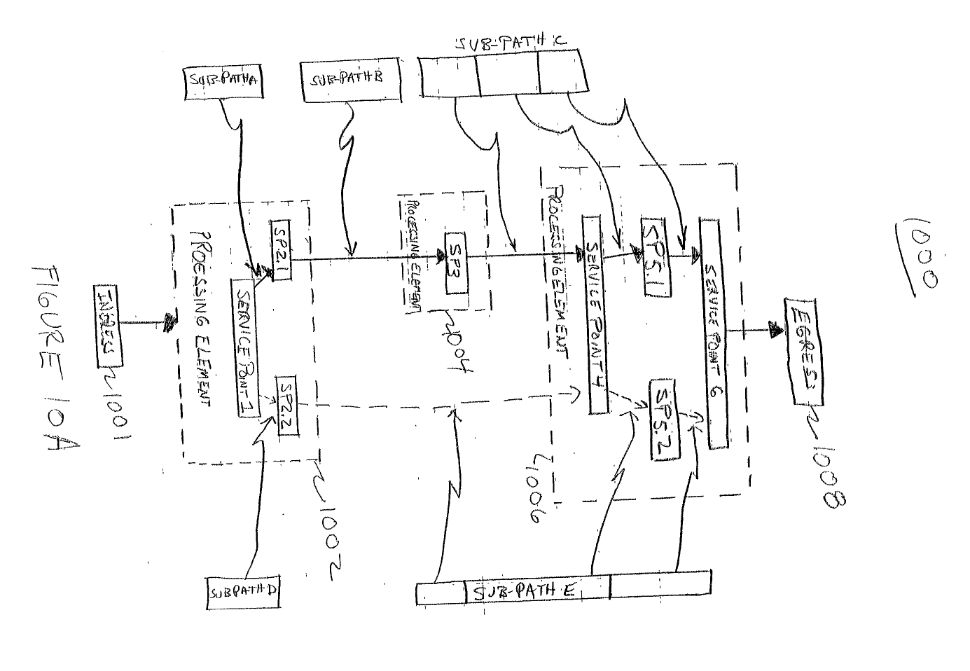

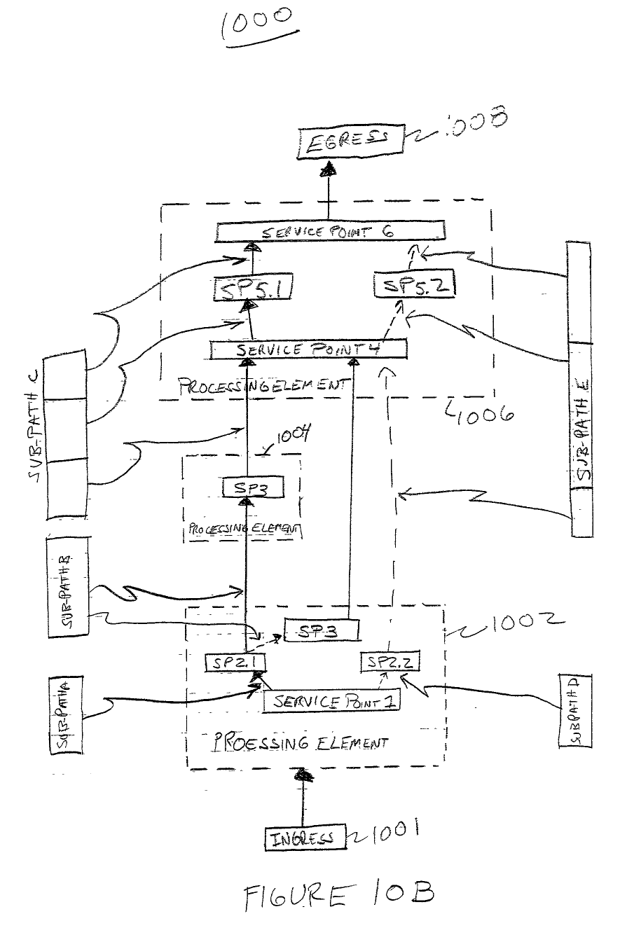

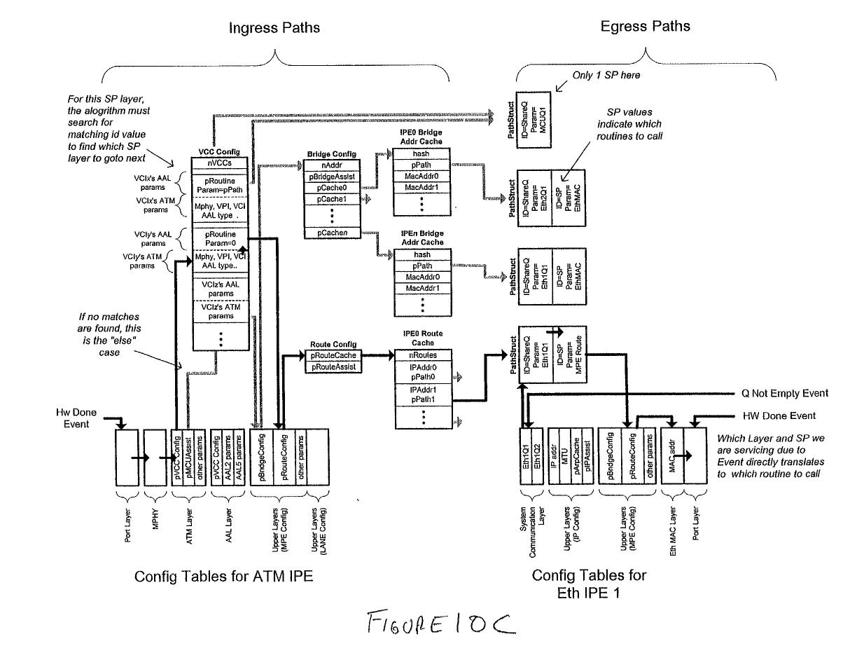

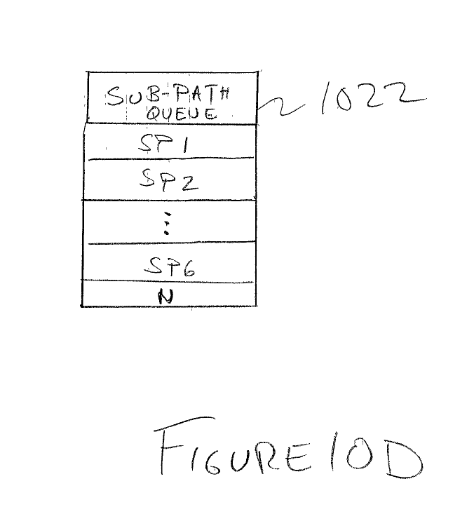

FIG. 10A shows a conceptual view of a logical data path traversing a generic multiple processor element system 1000 according to one embodiment of the present invention. As used herein, system 1000 includes multiple processing elements 1002-1008, which may be any type of processing device, such as a microprocessor. Dispersed in each functional element 1002-1008, are service points, SP1-SP6. Service points correspond to a portion of processing that must be performed. The processing may correspond to a protocol layer or a physical device or a servicing algorithm for a processing algorithm, such as scheduling events. Accordingly, each service maybe implemented with any combination of software, hardware and/or firmware. In the illustrative embodiment of device 102, shown in other figures, most of the processing element's service points are implemented in firmware at initialization of the device, whereas the physical wire interface service points are generally implemented in hardware to increase speed.

In addition to partitioning functionality to be performed, there maybe many possible service points to utilize in each processing element. In order to link the completion of a service point to the start of another service point, a message subsystem is utilized in the form sub-paths. In FIG. 10, sub-path A through sub-path C direct processing order from ingress 1001 to egress 1008 of data. Each sub-path (e.g., sub-path A) contains a pointer to the next service point. For instance sub-path A contains a pointer to service point 2.1. Upon completion of service point 2.1, service point 2.1 sends a message for a next pointer to be invoked. Sub-path B then sends a message to processing element 1002 to send the data to processing element 1004 for service point SP3 to complete.

If the service point exists on the same processing element, the sub-path can be stored locally on the processing element's associated memory (such as cache or assigned memory) or internal buffer. Otherwise, if the next service point exists on a different processing element, then the service point will typically send a message to some type of shared structure, such as main memory or a queue, to obtain the next pointer in which the send the transaction. Accordingly, each sub-path provides the information (a map) necessary to link the next service point or list of service points. For instance, sub-path C contains multiple pointers of to service points for consecutive execution of processing, wherein a logical path is the sequence of service points taken—or the concatenation of sub-paths from ingress 1001 to egress of data 1008.

The beauty of processing system 1000 is that a service point may be moved off a processing element dynamically. For instance, FIG. 10B shows processing system 1000 where processing element 1002 and 1003 both contain firmware functionality code associated with performing the same service point SP3. In essence processing element 1004, contains a redundant spare service point SP3, in the event processing element 1002 becomes overloaded with a processing load. To relieve processing element 1002, service point functionality performed at SP3 is moved to processing element 1004. All that needs to be changed, in order to accomplish this functional redistribution is to change the contents of sub-path B's pointer to point to SP3 in processing element 1004. Thereafter, upon completion of service point functionality associated with SP2.1 processing will be moved off processing element 1002 to processing element 1004 via a modified sub-path B.

Now, assume that processing element 1002, which in this embodiment is servicing ingress of data from a physical wire, is becoming exhausted handling processing of data received off the wire. Processing element 1002 can be freed-up of its processing load, simply by moving portions processing functionality to another processing element, which in this example is SP3 to processing element 1004. A simple change of the pointer in to sub-path B in memory (whether main or on local) can redirect the processing functionality associated with SP3. This, modification can be performed by a central processor (not shown in FIG. 10) or TMM 212 (shown in FIG. 2 et. seq.), if it receives a message from processor element 1002 that it is becoming over-loaded. At this point, the central processor or TMM 212 can pull alternative code of pointers from a table and write over sub-path B with a new pointer directing processing to move to processing element 1004. One tremendous advantage of this system 1000, is that costly down-loading of firmware and costly firmware code modifications (and or hardware modification or operating system modifications) can be avoided, simply by interspersing service points through out the functional processing elements of system 1000 and linking them with soft coded sub-paths. Activating certain sub-paths and deactivating other sub-paths can dramatically redistribute processing functionality anywhere service points exists with in processing elements.

As shown in FIG. 10B, the dotted line between SP2.1 and SP3 on processing element 1002 represents that data that once traversed to service point SP3 on processing element 1002, now flows directly to SP3 on processing element 1004. Also shown in FIG. 10B, on the right hand side, is an alternative logical path from ingress 1001 to egress 1008. This logical path includes sub-path D and sub-path E, wherein sub-path E includes three service points link pointers from SP 2.2 to SP4, from SP4 to SP5.2, and from SP5.2 to SP6.

In essence each service point is a function call to perform a process. At the completion of each service point's processing, a decision may be made if there are more than one option for the next service point, based on the results of the service point's processing. In either event, if the service point calls a next service point, it does so by indicating which service point to be called, and the sub-path directs the data to that next service point based on the pointer loaded in that sub-path.

FIG. 10C is a block diagram showing data ingress and egress paths from ATM to Ethernet functional blocks employing configuration tables according to one embodiment of the present invention. In this example, dark black lines show the logical path chosen and grey lines show other possible paths. Note that this diagram shows structures that are necessary for traversing a logical path form ingress to egress and therefore, some structures necessary for functionality are not shown. Additionally, sub-path pointers may be implemented and stored in a queue, for less complicated processing applications. A sample queue 1022 according to one embodiment of the present invention is shown in FIG. 10D, where it includes pointer entries from 1 to N. As will become more apparent below, a layer and/or service point may be skipped depending on the configuration of an IPE 202-208.

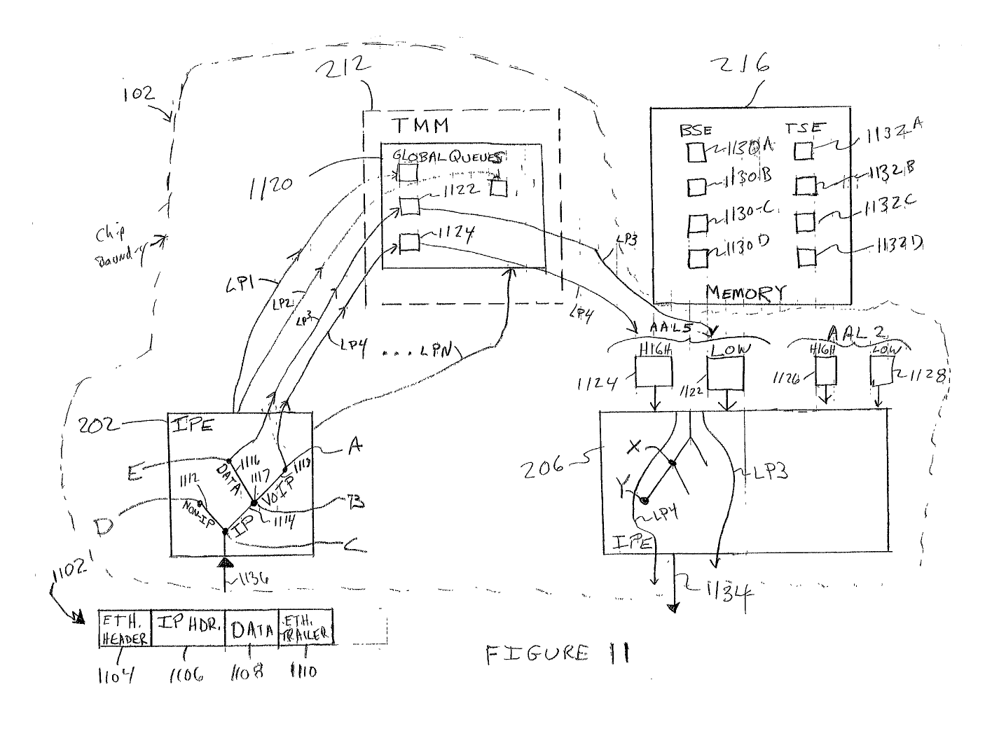

FIG. 11 is a block diagram illustrating transfer of data from Ethernet to an ATM protocol environment in device 102, according one illustrative embodiment of the present invention. Referring to FIG. 11, IPEs 202, 206, TMM 212 and main memory 216 are used for illustration purposes, however, the concepts derived from this example may easily be applied to other functional blocks in FIG. 2 or other distributed systems employing multiple functional blocks to hand-off and process data. Essentially, control overhead sent with each packet of information determines a logical path for the flow of data through device 102. That is, each functional block, e.g. blocks 202, 206, contain firmware, which perform functional processing on the contents of the data. Firmware, allows functional blocks 202, 206 to be programmable and process real-time applications where reliance on software operating systems would be inadequate to support real-time applications.

Global queues 1120 in TMM 212 acts as a messaging subsystem controlling ownership of or tracking data stored in memory 216. So, as data enters via 1136 functional block 202 such functional block 202 acts as a producer to a global queues 1120 by en-queuing transaction state entries and a logical path for the data to take. On egress block 206 acts as a consumer to global queues 1120 by reading transaction state entries from global queues 1120 and taking ownership of data stored in memory associated with each transaction state entry (a transaction state entry will be explained in more detail below, but it contains control information about a data payload including time stamps etc.). Thereafter, the functional block performs egress functionality and processing according to the sub-path received and eventually sends the data payload to its destination. Global queues 1120 resides in TMM 212, nevertheless it could reside in other devices in 102 such as functional blocks for which data is to be read, and/or memory 216.

The illustration of FIG. 11 will now be described in more detail starting with the flow of data from Ethernet to an ATM protocol environment. IPE 202 receives data in the form of an Ethernet packet 1102. IPE 202 recognizes that all data entering wire 1136 is in an Ethernet format, but IPE 202 does not know what will be contained in the Ethernet headers. Therefore, it is necessary for IPE 202 to examine the contents of control headers to determine what actions need to be taken with the data. IPE 202 disassembles packet 1102 by examining or removing bytes of the packet 1102, which in this example includes header 1104 and trailer 1110.

Next, IPE 202 determines whether packet 1102 is an IP type packet or a non-IP packet. If packet 1102 is a non-IP packet, then a sub-path 1112 (e.g., SPC-to-SPD) in IPE 202 is chosen. On the other hand, if it is determined that packet 1102 does contain an IP header 1106, then sub-path 1114 is chosen for packet 1102. Next, at service point B, IPE 202 determines whether the IP packet is in the form of data or voice over IP (VOIP). If it is data, then Service Point B calls, sub-path 1116 which performs processing associated with Service Points B to E. On the other hand, if the data is in the form of a voice conversation, then data follows sub-path 1118, which invokes service points B to A.

Once it has been determined whether the packet is VOIP or data, IPE 202 is ready to hand the data to IPE 206. Prior to doing so, IPE 202 notifies TMM 212 that it has information ready for transmission to IPE 206. At this point, IPE 202 is a producer (as opposed to a consumer) of global queues 1120 in TMM 212. Prior to handing off the information, IPE 202 chooses a queue (e.g., queues 1122, 1124, 1126, or 1128) based on the service point in the sub-path. If the data were in the form of VOIP it would be placed in the AAL5 layer high priority queue 1124. If the data was non-voice data over IP, then it would be placed in AAL5 layer, low priority queue 1122. As described above these queues are FIFOs, to ensure data is handled in order of reception to avoid out-of-order flow.

When producers add data to queues in TMM 212, a queue status goes from empty to not empty in global queue 1120. Accordingly, TMM 212 sends a message to the functional block that it has data ready for it in a particular queue. In this example, TMM 212 notifies IPE 206 that data is available in any of the queues 1124-1128. At this point, IPE 206 acts as a consumer of global queues 1120. IPE 206 reads information from its high priority queues 1124, 1126 first, and then low priority queues 1122, 1128. Reads only take place when IPEs are ready reducing the need for polling, interrupts and other processing bottlenecks associated with many convention devices. Sub-paths and service point information in the queues 1124-1128 from other functional blocks producers, inherently provide IPE 206 with a sub-path for the data to begin egress. For example, assuming the data in FIG. 11 is VOIP in accordance with multiple protocol encapsulated (MPE) IP, then the AAAL5 high priority egress sub-path will be taken out of IPE 206. The way in which voice data egresses through IPE 206 may also depend on the service point associated with a portion of processed communications data. In any event there is a single service point for data to enter IPE 206 from IPE 202. So, the service point acts as an egress pointer for IPE 206, to accept data, which in this example is one of four sub-paths LP1-LP4 from queues 1124-1128, respectively. As data egresses IPE 206 it may take several paths depending on the type of data, for instance, AAL2 voice, AAL5 voice, etc. until data is sent over the wire 1134. In this example, Y is shown to illustrate that it is service point at the completion of service point processing performed between X and Y. At SPY a next sub-path is called which map the next service point processing to be performed by the device.

As may be appreciated by those skilled in the art, service points and sub-paths from ingress through egress, permit functional blocks 202-208 to process data without the need to reexamine control/header information previously processed by another functional block. This processing of communications data reduces redundant processing and more efficiently speeds the flow of data from source to destination in a distributed system. Additionally, no master station (such as a central processor) for polling functional devices nor interrupts are necessary for the transfer and processing of data between functional blocks.

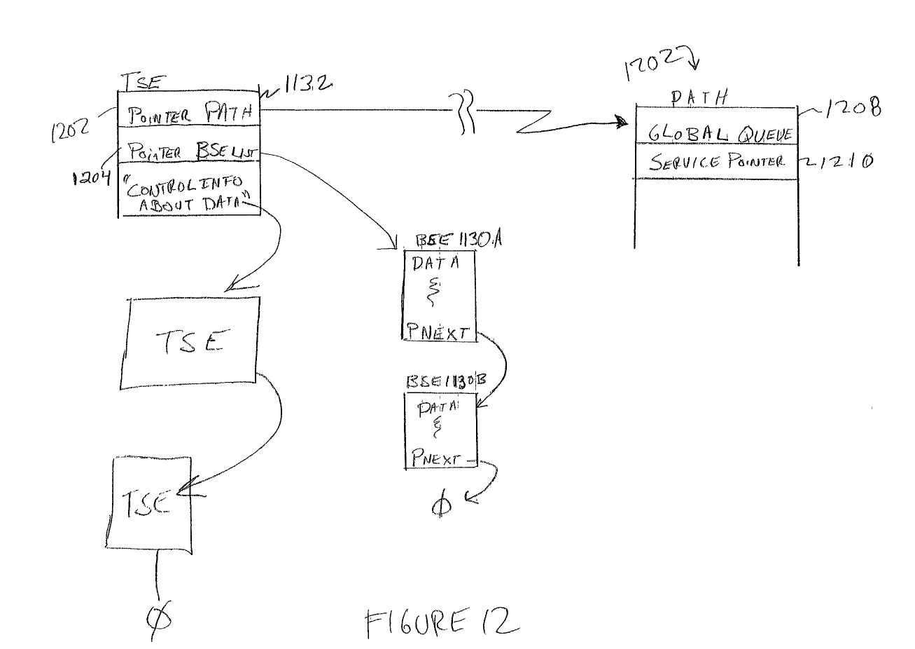

FIG. 12 is a block diagram of buffer state entries 1130 and transaction state entries 1132 used to track data in memory 216, according to one embodiment of the present invention. Referring to FIG. 12, non-control data (e.g., the data payload) is stored in memory 216 upon ingress into device 102. Memory contains buffer state entries (BSEs) 1132A-D and transaction state entries (TSEs) 1132A-D. Essentially BSEs 1130 contain small increments of data that are linked together to form a larger chunk of data. Each BSE 1130A, 1130B contains data and a link to a next BSE unless there isn't any more data associated with a particular portion of data, such as an end (or termination of data packet 1130B (shown as 0). TSE 1132 contains a pointer path 1202. The path 1202 is also a list in main memory (not shown) that indicates which service points to send the data payload (e.g., ATM, Ethernet functional blocks) and a service pointer 1210 indicating how this packet is going to be manipulated (e.g., IP Routed, Ehternet Bridged, etc.). So in this example a service point instructs a functional block what action to perform upon data on egress. TSEs 1132 includes an assigned global queue pointer indicating a path for portions of BSE data and assigned service points that carry a chunk of data until its termination point (shown as 0 in FIG. 12). There may be multiple service points employed with in a sub-path list to speed up data flow and reduce processing redundancies from one IPE to another. Additionally, service points can be used at different protocol layers depending on whether data is bridged, routed, etc.

Again, service points and sub-paths eliminate the need to view the contents of a packet/cell to reestablish its composition, destination and/or origin. Additionally, data payloads are stored in memory one time. Pointers to memory act as a means to transfer data to the various functional blocks without moving the physical payload in or out of memory. So redundant memory reads and writes are reduced saving precious time, especially when dealing with real-time data communication.

FIG. 13 is another conceptual view 1300 of a concatenation of sub-paths A-G forming a logical path 1302 from ingress to egress of data, according an illustrative embodiment of the present invention. View 1300 shows data transfer from ingress 1312 through functional block 204 and to egress 1314 through functional block 206. As data enters functional block 204, decisions are made at various service points 1, 2.1, 3.2, 4.2, 5.4 in block 204. At the completion of each service point (i.e., completion of its functionality) a next sub-path is called from memory (either a configuration table, queue, in main or local memory). Other potential sub-paths are shown generally as 1304. At each service point, a sub-path is called which invokes a pointer in which to perform the next processing according to a next service point. Each service point (e.g., 1, 2.1, 3.2, 4.2, 5.4) chooses a next service point based on the type of data payload entering functional block 204 in this example, whereas the sub-path determines where the service point is performed. In this example, data flows to functional block 206, but could easily follow a sub-path to other functional devices depending on the data payload and its destination.

Each decisional point 1, 2, 3, 4, 5 in the ingress path 1312 represents a functional layer as shown in ingress tables 1308. Within each layer there may be multiple potential service points (for Rx Layer 4 there are service points 4.k, 4.1, 4.2), depending on the configuration of a functional block. Prior to transfer of data through a functional block 206, a path index 1318-1325 is selected based on the previous decisional point 5.1-5.4. In this example, service point 5.4 generates a message to TMM 212 (not shown in FIG. 13), which in turn generates a corresponding message to functional block 206 for the entry of data on the egress side 1314. Sub-path index (or pointer) 1324 facilitates functional block 206 to initiate processing of data sent from functional block 204, based on the sub-path 1324 and without the need to reexamine the data payload control information to determine how to initiate processing.

In this embodiment, once an egress portion 1314 of logical path 1302 is chosen via sub-path pointer 1324, no service points need to be reevaluated in order for data to egress 1314. However, in more robust systems, multiple service points could be used to help facilitate processing of communications data. Additionally, protocol layers may be skipped to facilitate different levels of protocol functionality tailored to a particular communications system.

The foregoing description of embodiments of the present invention has been presented for purposes of illustration and description only. It is not intended to be exhaustive or to limit the invention to be forms disclosed. Obviously, many modifications and variations will be apparent to practitioners skilled in the art.

What is claimed is:

1. A system for dynamically distributing functionality in a multiprocessor communication platform, wherein said platform provides a convergence point for distribution of multiple heterogeneous communications data to and from external devices connected to said platform, comprising:
a plurality of processing devices, configured to programmably execute processing functionality associated with processing said data according to characteristics necessary to distribute said data to and from external devices, and
a programmable path structure, that maps a logical path for the processing of said data from ingress to egress of said data, to and from said platform, wherein said path structure contains links to portions of said processing functionality performed by said plurality of processing devices, wherein said programmable structure may be modified by programmably modifying said links to distribute processing functionality anywhere within said plurality of processing devices.

2. The system of claim 1, wherein said platform performs conversions of data to and from multiple communication protocol formats including incompatible communication protocols formats.

3. The system of claim 1, wherein said platform performs conversion of data across multiple layers of heterogeneous communications protocol layers.

4. The system of claim 1, wherein said execution of processing functionality may be dynamically distributed and balanced across said plurality of processing devices by monitoring whether any of said plurality of processing devices is becoming over-burdened with a specific processing task, and off-loading said specific processing task to another of said processing devices that is not over burdened with said task; thereby reaching a balance of functional processing capacity associated with said specific processing task.

5. The system of claim 4, wherein said off-loading of said specific processing task is accomplished by modifying at least one of said links associated with a portion of performing functionality associated with said specific processing task, so that said modified link points to said processing device that is not over burdened with said task.

6. A processing platform, comprising:
a plurality of processing elements, configured to process and route data;
a plurality of service points located within said plurality of processing elements such that at least one of said plurality of service points is located within each of said plurality of processing elements, wherein each of said service points is configured to perform a portion of processing of said data; and
a plurality of sub-paths, programmably configured to link a completion of processing of one of said service points to a start of processing of another of said service points such that each said portion of processing of said data can be performed in a specific order and at any location within said plurality of processing elements specified by said sub-paths.

7. The processing platform of claim 6, wherein said processing platform is a single communications platform, configured to route and process heterogenous communications data.

8. The processing platform of claim 6, wherein one of said service points is comprised of hardware.

9. The processing platform of claim 6, wherein one of said service point is comprised of firmware.

10. The processing platform of claim 6, wherein one of said service points is comprised of software.

11. The processing platform of claim 6, wherein each of said service points is pre-configured to perform a specific processing functionality.

12. The processing platform of claim 6, further comprising a concatenation of a select set of said plurality of sub-paths forming a logical path for processing of data.

13. The processing platform of claim 12, wherein said logical path can be changed by modifying at least one of said select set of said plurality of sub-paths.

14. The processing platform of claim 6, further comprising at least one sub-path that is not configured to point to a next service point and prevent certain data from being processed by a next service point.

15. A communications device, comprising:
a plurality of interconnected functional blocks configurable to perform portions of processing of streaming communications data, each of said portions having at least one service point that causes generation of a corresponding message; and
a messaging subsystem, coupled to said plurality of functional blocks, that carries said corresponding message thereby to prompt another one of said functional blocks to undertake a portion of said processing.

16. The device as recited in claim 15 wherein said plurality of functional blocks comprise a microprocessor.

17. The device as recited in claim 15 wherein said plurality of functional blocks comprise a digital signal processor.

18. The device as recited in claim 15 wherein said service point exists on a separate protocol layer of said device.

19. The device as recited in claim 18 wherein said service point occurs at a termination of said each of said portions.

20. A method of managing communications data, comprising:
performing, in a plurality of interconnected functional blocks, portions of processing of streaming communications data, each of said portions having at least one service point that causes generation of a corresponding message; and
carrying said corresponding message thereby to prompt another one of said functional blocks to undertake a portion of said processing.

21. The method as recited in claim 20 wherein said plurality of functional blocks comprise a microprocessor.

22. The method as recited in claim 20 wherein said plurality of functional blocks comprise a digital signal processor.

23. The method as recited in claim 20 wherein said service point exists on a separate protocol layer of said device.

24. The method as recited in claim 23 wherein said service point occurs at a termination of said each of said portions.

25. A communications device, comprising:
a plurality of functional blocks, including a microprocessor and a digital signal processor, that cooperate to perform portions of processing of streaming communications data, each of said portions having at least one service point that causes generation of a corresponding message;
a cross-bar that interconnects said plurality of functional blocks; and
a messaging subsystem, coupled to said plurality of functional blocks, that employs said cross-bar to carry said corresponding message thereby to prompt another one of said functional blocks to undertake a portion of said processing.

26. The device as recited in claim 25 wherein said plurality of functional blocks comprise a microprocessor.

27. The device as recited in claim 25 wherein said plurality of functional blocks comprise a digital signal processor.

28. The device as recited in claim 25 wherein said service point exists on a separate protocol layer of said device.

29. The device as recited in claim 25 wherein said service point occurs at a termination of said each of said portions.

30. A communication processing platform, comprising:
a plurality of processing elements interconnected and configured to process data;
a plurality of service points interspersed throughout said processing elements such that at least one service point exists in each of said plurality of processing elements, wherein each of said service points is configured to perform a specific segment of processing functionality; and
a sub-path pool, containing a plurality of sub-paths, each of said sub-paths containing a pointer to at least one service point, whereupon completion of a specific segment of processing functionality associated with at least one of said service points, said completed service point calls a next sub-path from said sub-path pool, which generates a message providing a link to transport any data associated with said completed segment of processing functionality to a next service point.

31. The communication processing platform of claim 30, wherein said sub-path pool is configuration table.

32. A communication processing platform, comprising:
a plurality of processing elements interconnected and configured to process data;
a plurality of service points interspersed throughout said processing elements such that at least one service point exists in each of said plurality of processing elements, wherein each of said service points is configured to perform a specific segment of processing functionality; and
a path structure, containing 1 to N service point pointers, wherein N is any number greater than 1, whereupon completion of a specific segment of processing functionality associated with at least one of said service points, said completed service point sends a message to said path structure, which invokes said path structure to send said 1 to N service point pointers to at least one of said plurality of said processing elements, thereby providing a processing order in which to perform service points.

33. The communication processing platform of claim 32, wherein said path structure is a queue.

34. A communications device, comprising:
an interconnected plurality of disparate functional blocks configurable to perform portions of processing of communications data; and
a path managing subsystem, coupled to said plurality of disparate functional blocks, that programmably defines a logical path for said communications data encompassing at least some of said plurality of said disparate functional blocks.

35. The device as recited in claim 34, wherein said plurality of disparate functional blocks comprise a microprocessor.

36. The device as recited in claim 34 wherein said plurality of disparate functional blocks comprise a digital signal processor.

37. The device as recited in claim 34 wherein said logical path is based on a protocol environment surrounding said device.

38. The device as recited in claim 34 wherein said logical path is based on a presence of streaming communications data in said communications data.

39. The device as recited in claim 34 wherein said logical path is based on a packet type in said communications data.

40. A method of managing communications data, comprising:
providing an interconnected plurality of disparate functional blocks configurable to perform portions of processing of communications data; and
programmably defining a logical path for said communications data encompassing at least some of said plurality of said disparate functional blocks.

41. The method as recited in claim 40 wherein said plurality of disparate functional blocks comprise a microprocessor.

42. The method as recited in claim 40 wherein said plurality of disparate functional blocks comprise a digital signal processor.

43. The method as recited in claim 40 wherein said logical path is based on a protocol environment surrounding said device.

44. The method as recited in claim 40 wherein said logical path is based on a presence of streaming communications data in said communications data.

45. The method as recited in claim 40 wherein said logical path is based on a packet type in said communications data.

46. A communications device, comprising:
an interconnected plurality of disparate functional blocks configurable to perform portions of processing of communications data;
a cross-bar that interconnects said plurality of functional blocks; and
a path managing subsystem, coupled to said plurality of disparate functional blocks, that programmably defines a logical path for said communications data encompassing at least some of said plurality of said disparate functional blocks.

47. The device as recited in claim 46 wherein said plurality of disparate functional blocks comprise a microprocessor.

48. The device as recited in claim 46 wherein said plurality of disparate functional blocks comprise a digital signal processor.

49. The device as recited in claim 46 wherein said logical path is based on a protocol environment surrounding said device.

50. The device as recited in claim 46 wherein said logical path is based on a presence of streaming communications data in said communications data.

51. The device as recited in claim 46 wherein said logical path is based on a packet type in said communications data.
